(19) United States
(12) Patent Application Publication
(10) Pub. No.: US 2006/0123961 A1
(43) Pub. Date: Jun. 15, 2006

(54) Offset push stick

(76) Inventor: Norston Fontaine, Minneapolis, MN (US)

Correspondence Address: CROMPTON, SEAGER & TUFTE, LLC, 1221 NICOLLET AVENUE, SUITE 800, MINNEAPOLIS, MN, 55403-2420, US

(21) Appl. No.: 11/286,744

(22) Filed: Nov. 23, 2005

Related U.S. Application Data
(60) Provisional application No. 60/630,338, filed on Nov. 23, 2004.

(51) Int. Cl. B27B 25/10

(52) U.S. Cl. 83/436.2

(57) ABSTRACT

An offset push stick for engaging workpieces across the surface of a worktable is disclosed. An offset push stick in accordance with an illustrative embodiment of the present invention may include a main body having a front face and a rear face, and a handle extending away from the main body and having an offset configuration relative to the main body.

This application claims priority to U.S. Provisional Application Ser. No. 60/630,338 filed Nov. 23, 2004.

### FIELD

The present invention relates generally to the field of woodworking. More specifically, the present invention pertains to offset push sticks for engaging workpieces across the surface of a worktable.

### BACKGROUND

It is common in many woodworking applications to utilize a push stick to engage workpieces across the surface of a worktable. In table saw applications, for example, such devices can be used to hold a board or other such workpiece firmly against a rip fence while advancing the workpiece over or through the cutting blade. In other applications such as router applications, such devices can be used to hold the workpiece flush against the top surface of the worktable and fence as the workpiece is advanced against a router bit.

### SUMMARY

The present invention relates generally to offset push sticks for engaging workpieces across the surface of a worktable. An offset push stick in accordance with an illustrative embodiment of the present invention may include a main body having a front face and a rear face, and a handle extending away from the main body and having an offset configuration relative to the main body. A top section of the main body may have an arcuate shape extending from a first (i.e. leading) end of the device to a second (i.e. trailing) end thereof. A bottom section of the main body, in turn, may have a generally flat configuration with an elastomeric strip that grips the top surface of the workpiece and a notch configured to catch over the edge of the workpiece. An angled joint between the main body and the handle can be configured to orient the handle at various angles relative to the main body.

### BRIEF DESCRIPTION OF THE DRAWINGS

FIG. 1 is an angled front perspective view showing an illustrative push stick in accordance with an exemplary embodiment of the present invention;

FIG. 2 is a left side perspective view showing the illustrative push stick of FIG. 1 in greater detail;

FIG. 3 is a front perspective view showing the illustrative push stick of FIG. 1;

FIG. 4 is a top perspective view showing the illustrative push stick of FIG. 1 in greater detail;

FIG. 5 is an angled rear perspective view showing the illustrative push stick of FIG. 1 in greater detail; and

FIG. 6 is an angled top perspective view showing an illustrative storage tray in accordance with an illustrative embodiment of the present invention.

### DETAILED DESCRIPTION

The following description should be read with reference to the drawings, in which like elements in different drawings are numbered in like fashion. The drawings, which are not necessarily to scale, depict selected embodiments and are not intended to limit the scope of the invention. Although examples of construction, dimensions, and materials are illustrated for the various elements, those skilled in the art will recognize that many of the examples provided have suitable alternatives that may be utilized.

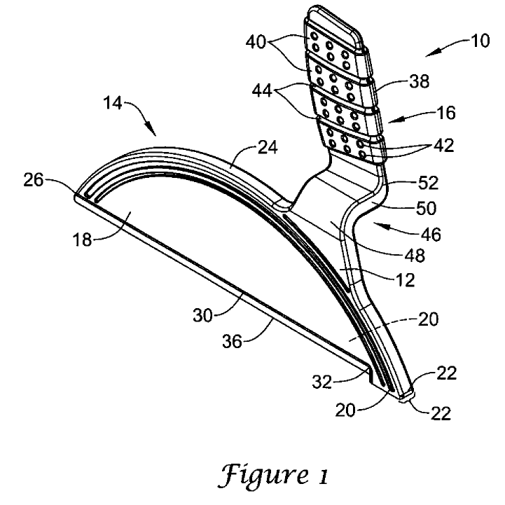

FIG. 1 is angled front perspective view showing an illustrative push stick 10 in accordance with an exemplary embodiment of the present invention. As shown in FIG. 1, the push stick 10 may include a structure 12 having a main body 14 and a handle 16. The main body 14 of the structure 12 may have a vertically oriented front face 18, a vertically oriented rear face 20 (hidden), and a thickness 22. In the illustrative embodiment of FIG. 1, the main body 14 may have a semi-circular shape with an arcuate top section 24 that extends from a first (i.e. leading) end 26 of the push stick 10 to a second (i.e. trailing) end 28 thereof. A generally flat bottom section 30 of the main body 14, in turn, may extend from the first end 26 of the structure to a second location 32 wherein the main body 14 protrudes downwardly to form a notch 34 configured to catch over the edge of the workpiece and, in some cases, to facilitate tracking of the push stick 10 within the guide channel of a worktable.

The push stick 10 can be fabricated from a polymeric material using a suitable process such as injection molding, allowing the entire structure 12 to be fabricated as a single piece. Examples of suitable polymeric materials that can be utilized to form the push stick 10 may include, but are not limited to acrylonitrile butadiene styrene (ABS), polypropylene (PP), polyvinylchloride (PVC), or nylon. The push stick 10 will typically be formed from a relatively rigid material capable of resisting bending or flexing resulting from pressure exerted thereon by the user. In certain embodiments, for example, the push stick 10 may be fabricated from a 20% glass filled nylon or polycarbonate material, allowing the push stick 10 to withstand warping or breaking. It should be understood, however, that other suitable materials and/or fabrication techniques could be utilized to form the push stick 10, if desired.

As can be further seen in FIG. 1, a strip 36 of elastomeric material can be attached to the bottom section 30 of the main body 14 to facilitate gripping of the push stick 10 against the surface of the workpiece. In certain embodiments, for example, the elastomeric strip 36 may comprise a rectangular strip of neoprene, Nitrile, EPDM, or other commercially available rubber. The elastomeric strip 36 can be adhesively attached to the bottom section 30 of the main body 14 using a suitable adhesive or epoxy, or can be overmolded to the bottom section 30 the main body 14, if desired.

The handle 16 may include a handle grip 38 comprising a number of raised sections 40 protruding outwardly from the handle 16. Each of the raised sections 40 can include a number of dimples 42 thereon that facilitate gripping, and can be spaced apart from each other via a gap 44 that imparts a degree of flexibility to the handle 16. The handle grip 38 can be formed integral with the remaining structure 12, or alternatively, can be fabricated as a separate piece that is later attached to the handle 16 by overmolding, adhesion, or other suitable technique. In some embodiments, for example, the handle grip 38 can be fabricated by overmolding a rubber grip over the surface of the handle 16.

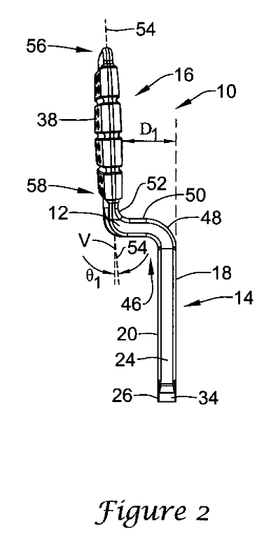

The handle 16 can be joined to the main body 14 via an angled joint 46, which as is described in greater detail below with respect to FIGS. 2-4, can be configured to orient the handle 16 at various angles relative to the main body 14. In certain embodiments, the angled joint 46 can include a first bend section 48, a relatively straight section 50, and a second bend section 52. As can be further seen in the left side perspective view of FIG. 2, the straight section 50 of the joint 46 can be oriented in a direction substantially orthogonal to the vertically oriented faces 18,20 of the main body 14, which offsets the handle 16 a distance D₁ away from the front face 18. In use, such offset of the handle 16 away from the first face 18 provides a clearance space for the user to better grip the handle grip 38 without interference with the rip fence, which typically lies flush against the first face 18.

The first and second bend sections 48,52 can each be configured to gradually transition the positioning of the handle 16 away from the main body 14 in order to reduce any stress within the joint 46 induced when the user applies a force to the handle 16. The thickness of each section 48,50,52 may be sufficient such that any forces imparted to the handle 16 are transmitted to the main body 14 without significant bending or flexion, which can cause the push stick 10 to become skewed on the surface of the workpiece.

As can be further seen in FIG. 2, the second bend section 52 of the joint 46 can be configured to orient the length of the handle 16 along an axis 54 offset an angle θ₁ away from vertical V. In certain embodiments, for example, the bend section 52 can be configured to orient the length of the handle 16 at an angle θ₁ of about 1° to 5°, and more specifically 2° away from vertical V, tilting the handle 16 away from the main body 14 such that the clearance distance D₁ between the handle 16 and the main body 14 is slightly greater towards the top portion 56 of the handle 16 than at the bottom portion 58 thereof. In use, such tilted configuration transmits a horizontal force component to the main body 14 that acts to hold the workpiece flush against the surface of the rip fence. Alternatively, in router applications or the like where the push stick 10 is typically used with the front face 18 oriented horizontally relative to the worktable, such tilted configuration acts to transmit a vertical force component to the workpiece to hold it flush against the top surface of the router table.

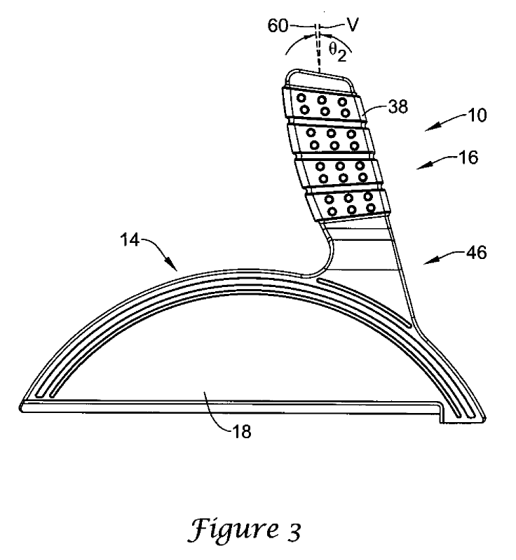

FIG. 3 is a front perspective view showing the illustrative push stick 10 of FIG. 1. As can be further seen in FIG. 3, the joint 46 can be further configured to forwardly orient the handle 16 along a second axis 60 offset a second angle θ₂ away from vertical V. In certain embodiments, for example, the handle 16 can be offset at an angle θ₂ of about 10° to 20°, and more specifically 150 away from vertical V, orienting the handle 16 forward slightly to the left in FIG. 2 and toward the leading portion of the push stick 10. In use, such forward orientation of the handle 16 acts to transmit a downward force against the surface of the workpiece to prevent kickback, and helps to keep the user's hands away from the fence.

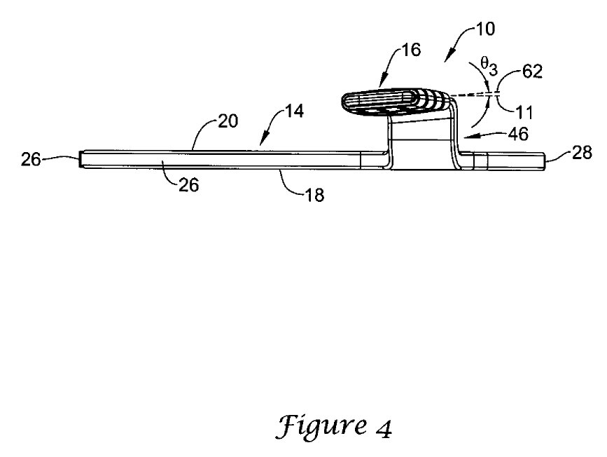

As can be further understood by reference to FIG. 4, the general width of the handle 16 can be oriented along a third axis 62 offset at an angle θ₃ away from a horizontal axis H aligned substantially parallel to the front and rear faces 18,20 of the main body 14. In certain embodiments, for example, the width of the handle 16 can be skewed at an angle θ₃ of about 1° to 10°, and more specifically 5° away from horizontal H, although other angles greater or lesser than these values are possible. In use, such skewed configuration of the handle 16 acts to apply a horizontal force component to the workpiece that forces it flush against the face of the rip fence as the user advances the push stick 10 forward. Moreover, such configuration serves to better align the push stick 10 against the surface of the workpiece.

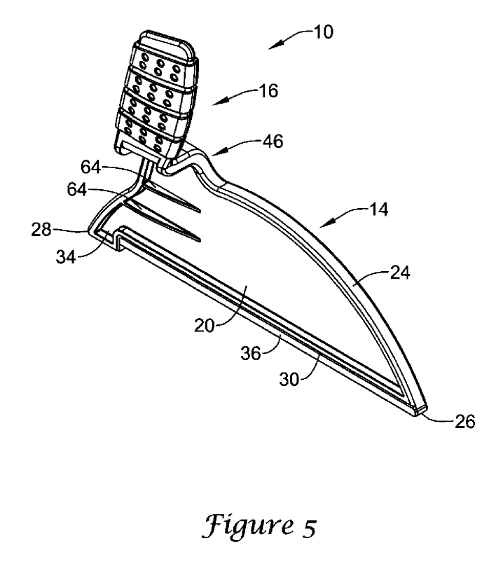

FIG. 5 is an angled rear perspective view showing the illustrative push stick 10 of FIG. 1 in greater detail. As can be seen in FIG. 5, the rear face 20 of the main body 14 can have a substantially hollowed configuration, and can include a number of structural ribs 64 that strengthen the trailing portion of the push stick 10. While the illustrative push stick 10 is shown having a hollowed configuration, it should be understood that the rear face 20 of the main body 14 could be substantially flat, similar to the front face 18 depicted, for example, in FIG. 1.

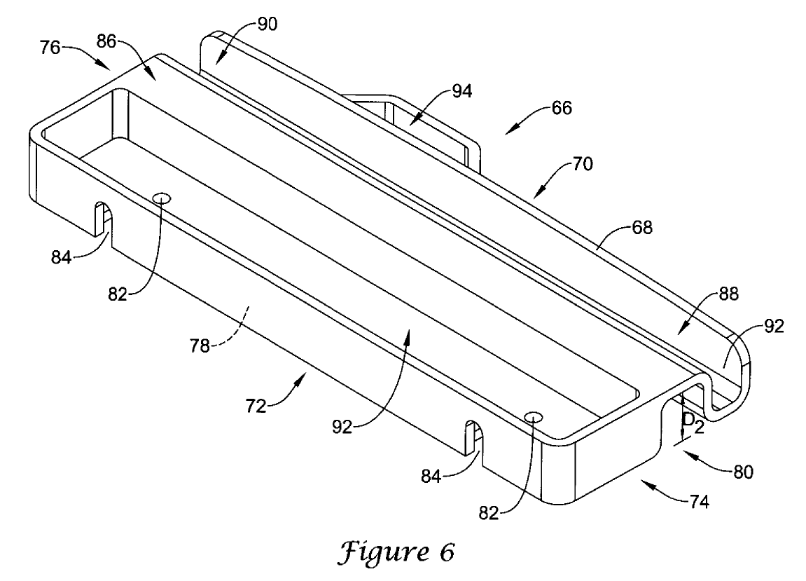

Turning now to FIG. 6, an illustrative storage tray 66 for use with the offset push stick 10 of FIG. 1 will now be described. As shown in FIG. 6, holster 66 may comprise a structure 68 having a first side 70, a second side 72, a first end 74, and a second end 76. A bottom side 78 (hidden) of the structure 68 can be configured to lie flat on the top surface of a router table, saw table, or other such surface, and can include an indented section 80 that spans the width of the holster 66 from the first end 74 of the structure 68 to the second end 76. The indented section 80 can be recessed a depth D₂ into the bottom side 78 sufficient to permit the indented section 80 to be placed over the faces of a rip fence, a mounted block of wood, or other such structure in order to hold the holster 66 firmly in place on the table surface. A number of mounting holes 82 and/or slots 84 can be further provided to secure the holster 66 to the table surface, if desired. Alternative, or in addition, a double-side tape could be utilized to secure the holster 66 to the table surface.

A top side 86 of the structure 68 may include a U-shaped slot 88 extending along the entire width of the structure 68. The U-shaped slot 88 can be dimensioned to firmly receive the push stick 10 in an upright position (see FIG. 1) with the first end 26 of the push stick 10 aligning generally with a first end portion 90 of the slot 88 and the second end 28 of the push stick 10 aligning generally with a second end portion 90 of the slot 88. In such configuration, the front face 18 of the push stick 10 is oriented towards the second end 72 of the structure 68. The U-shaped slot 88 can be configured, however, to receive the push stick 10 in an opposite manner, with the front face 18 of the push stick 10 oriented towards the first end 70 of the structure 68, if desired.

The holster 66 may further include a number of other compartments and/or slots for the convenient storage of other instruments or tools. A rectangular tray 92 inset within the top side 86 of the structure 68, for example, can be configured to receive a number of pencils, pens, rulers, or other desired utensils. A second holster 94 on the first side 70 of the structure 68, in turn, can be configured to receive a tape measure or other such instrument, if desired.

Having thus described the several embodiments of the present invention, those of skill in the art will readily appreciate that other embodiments may be made and used which fall within the scope of the claims attached hereto. Numerous advantages of the invention covered by this document have been set forth in the foregoing description. It will be understood that this disclosure is, in many respects, only illustrative. Changes may be made in details, particularly in matters of shape, size and arrangement of parts without exceeding the scope of the invention.

What is claimed is:

1. An offset push stick, comprising:
a main body having a front face and a rear face; and
a handle extending away from the main body and having an offset configuration relative to the main body.

2. The offset push stick of claim 1, wherein the main body further includes a top section and a bottom section.

3. The offset push stick of claim 2, wherein the bottom section of the main body includes a notch.

4. The offset push stick of claim 2, wherein the bottom section of the main body includes a strip of elastomeric material.

5. The offset push stick of claim 2, wherein the bottom section of the main body has a generally flat shape.

6. The offset push stick of claim 2, wherein the top section of the main body has an arcuate shape.

7. The offset push stick of claim 1, wherein the main body and handle are integrally formed from a single piece of material using an injection molding process.

8. The offset push stick of claim 1, wherein the main body and handle are formed from a polymeric material.

9. The offset push stick of claim 1, wherein the handle includes a handle grip.

10. The offset push stick of claim 9, wherein the handle grip includes a number of raised sections protruding outwardly from the handle.

11. The offset push stick of claim 1, further including an angled joint disposed between the main body and the handle.

12. The offset push stick of claim 11, wherein the angled joint includes a first bend section, a relatively straight section, and a second bend section.

13. The offset push stick of claim 12, wherein said bend and straight sections offset the handle a distance D₁ away from the front face of the main body.

14. The offset push stick of claim 12, wherein a length of the handle is oriented along a first axis offset a first angle θ₁ away from vertical.

15. The offset push stick of claim 12, wherein the handle is forwardly oriented along a second axis offset a second axis offset a second angle θ₂ away from vertical.

16. The offset push stick of claim 12, wherein a width of the handle is oriented along a third axis offset at an angle θ₃ away from a horizontal axis aligned substantially parallel with the front and rear faces of the main body.

17. The offset push stick of claim 1, further including a holster having a U-shaped slot adapted to store the offset push stick in a substantially upright position.

18. The offset push stick of claim 17, wherein said holster includes an indented bottom section adapted to attach the holster to a rip fence located on a worktable.
